(19) United States
(12) Patent Application Publication
(10) Pub. No.: US 2021/0195765 A1
(43) Pub. Date: Jun. 24, 2021

(54) DISPLAY PANEL, METHOD FOR MANUFACTURING DISPLAY PANEL, AND DISPLAY

(71) Applicant: CHONGQING KONKA PHOTOELECTRIC TECHNOLOGY RESEARCH INSTITUTE CO., LTD., Chongqing City (CN)

(72) Inventor: Shisong ZHENG, Chongqing City (CN)

(21) Appl. No.: 17/117,832

(22) Filed: Dec. 10, 2020

Related U.S. Application Data
(63) Continuation of application No. PCT/CN2019/126538, filed on Dec. 19, 2019.

(51) Int. Cl. H05K 5/00; B32B 15/04; B32B 38/00; B32B 3/04

(52) U.S. Cl. CPC H05K 5/0017; B32B 15/04; B32B 2457/20; B32B 3/04; B32B 2310/0843; B32B 38/0004

(57) ABSTRACT

A display panel, a method for manufacturing a display panel, and a display are provided. The display panel includes a bottom wall having a display region and folding walls arranged along edges of the bottom wall. The folding walls are fixedly arranged around the bottom wall, and a special-shaped graphic region is defined between each two adjacent folding walls to prevent interference during folding of each two adjacent folding walls. Each of the folding walls is bent from the special-shaped graphic region toward a side of the bottom wall away from the display region and fixed to the side of the bottom wall away from the display region.

### CROSS-REFERENCE TO RELATED APPLICATION(S)

This application is a continuation of International Application PCT/CN2019/126538, filed on Dec. 19, 2019, the entire disclosure of which is hereby incorporated by reference in its entirety.

### TECHNICAL FIELD

This disclosure relates to the field of display panels, and particularly to a display panel, a method for manufacturing the display panel, and a display.

### BACKGROUND

In recent years, with progress and maturity of flexible technology, a product portfolio of special-shaped screens has been greatly increased. A display panel such as the special-shaped screen generally includes an upper cover, a front plate, and a back plate that are arranged sequentially. The display panel is generally formed as follows: a plate is cut to form a plate body having a specific shape, and then the plate body is bent to obtain the display panel. During bending, folding walls of the display panel need to be bent, whereas a bottom wall of the display panel does not need to be bent. In the related art, a cutting pattern is generally in the shape of a rectangle, and there is a folding dead point between two adjacent folding walls during bending, such that the reliability of the folding walls after being bent is low.

Therefore, it is necessary to improve and develop the existing technologies.

### SUMMARY

In view of the above shortcomings in the related art, the disclosure aims to provide a display panel, a method for manufacturing the display panel, and a display, to solve a technical problem that in the related art, there is a folding dead point between two adjacent folding walls during bending, and the reliability of the display panel obtained after the folding walls are bent is low.

The technical solution adopted by the disclosure to solve the technical problems is as follows.

A display panel is provided. The display panel includes a bottom wall having a display region and folding walls arranged along edges of the bottom wall. A special-shaped graphic region is defined between each two adjacent folding walls to prevent interference during folding of each two adjacent folding walls. Each of the folding walls is bent from the special-shaped graphic region toward a side of the bottom wall away from the display region and fixed to the side of the bottom wall away from the display region.

According to the display panel, the special-shaped graphic region includes a first edge, a second edge, a third edge, a fourth edge, and a fifth edge. The first edge and the second edge are respectively located on two adjacent folding walls, the third edge and the fourth edge are located on the bottom wall and respectively connected to the first edge and the second edge, and the fifth edge is connected to the third edge and the fourth edge.

According to the display panel, the fifth edge is an arc edge, and a center of a circle where the arc edge is located is at the outside of the special-shaped graphic region.

According to the display panel, the special-shaped graphic region satisfies the following relationship:

$$\frac{36 {0}^{0}}{N} < ( zi 1 + zi 2 ) < \frac{36 {0}^{0}}{N} \times m$$

where N represents the amount of the folding walls, zi1 represents an angle defined between the first edge and an extended line of the third edge, zi2 represents an angle defined between the second edge and an extended line of the fourth edge, and the coefficient m>1.

According to the display panel, the coefficient in is selected from a range from 1.1 to 1.5.

According to the display panel, the bottom wall includes an upper cover, a front plate, and a back plate that are arranged sequentially. The front plate has a display region for luminous display.

According to the display panel, the bottom wall is a flexible plate body.

According to the display panel, a light-emitting source in the display region of the front plate is made of inorganic materials.

According to the display panel, the bottom wall includes a corner cutting tolerance reserved region arranged around the display region.

According to the display panel, the bottom wall further includes a folding tolerance reserved region arranged around the corner cutting tolerance reserved region.

According to the display panel, each of the folding walls includes a circuit region arranged around the folding tolerance reserved region and an edge cutting tolerance reserved region arranged around the circuit region.

A display is provided. The display includes multiple display panels and a frame, where each of the multiple display panels is the display panel described above. The multiple display panels are sequentially secured to the frame and sequentially electrically coupled with each other.

A method for manufacturing the display panel described above is provided. The method includes the following. A plate is provided. A cutting is performed on the plate to obtain a bottom wall and folding walls, where the folding walls are arranged along edges of the bottom wall and fixedly arranged around the bottom wall, and a special-shaped graphic region is defined between each two adjacent folding walls to prevent interference during folding of each two adjacent folding walls. The folding walls are folded to obtain the display panel.

According to the method for manufacturing the display panel, the cutting is performed on the plate to obtain the bottom wall and the folding walls as follows. A shape and a size of the special-shaped graphic region are determined. The cutting is performed on the plate according to the shape and the size of the special-shaped graphic region to obtain the bottom wall and the folding walls.

According to the method for manufacturing the display panel, the cutting is carried out by laser cutting.

The disclosure has the following advantages: since each two adjacent folding walls are cut to form the special-shaped graphic region, no mutual interference occurs during folding of each two adjacent folding walls, and thus no folding dead point is formed, such that the display panel has high reliability.

### BRIEF DESCRIPTION OF THE DRAWINGS

FIG. 1 is a schematic structural view of a plate body in the related art.

FIG. 2 is a schematic structural view of a display panel in a folding process in the related art.

FIG. 3 is a first schematic structural view of a bottom wall and folding walls of the disclosure.

FIG. 4 is a schematic structural view of a display panel of the disclosure.

FIG. 5 is a second schematic structural view of a bottom wall and folding walls of the disclosure.

FIG. 6 is a third schematic structural view of a bottom wall and folding walls of the disclosure.

FIG. 7 is an exploded view of a bottom wall of the disclosure.

FIG. 8 is a schematic structural view of a bottom wall and folding walls of the disclosure.

FIG. 9 is a schematic structural view of a display panel of the disclosure.

FIG. 10 is a schematic structural view of a display of the disclosure.

FIG. 11 is a schematic flow chart illustrating a method for manufacturing a display panel according to implementations of the disclosure.

FIG. 12 is a schematic flow chart illustrating an operation at block 200 illustrated in FIG. 11 according to implementations.

### DETAILED DESCRIPTION

To describe objectives, technical solutions, and advantages of the disclosure more clearly and completely, the following describes implementations in detail with respect to the accompanying drawings. It should be understood that the implementations described herein are merely intended to explain the disclosure rather than limit the disclosure.

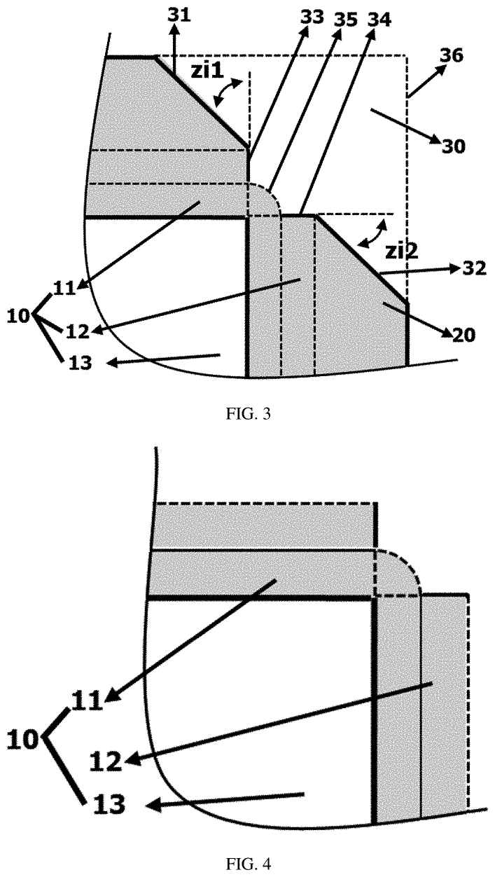

As illustrated in FIG. 3 to FIG. 10, implementations of the disclosure provide a display panel.

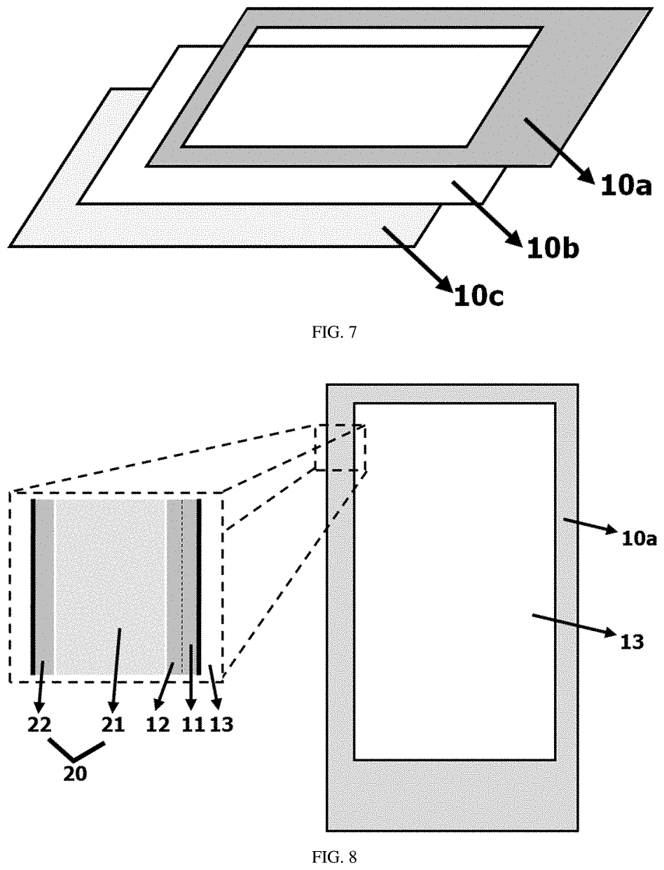

As illustrated in FIG. 3, FIG. 4, and FIG. 7, a display panel is provided according to the disclosure. The display panel includes a bottom wall 10 having a display region 13 (illustrated in FIG. 8) and folding walls 20 arranged along edges of the bottom wall 10. The folding walls 20 are fixedly arranged around the bottom wall 10. A special-shaped graphic region 30 is defined between each two adjacent folding walls 20 to prevent interference during folding of each two adjacent folding walls 20. The folding wall 20 is bent, from the special-shaped graphic region 30, toward a side of the bottom wall 10 away from the display region, and fixed to the side of the bottom wall 10 away from the display region. The special-shaped graphic region 30 herein refers to a space region between two adjacent folding walls 20. Each folding wall 20 can be folded to the back of the bottom wall 10 and is hidden.

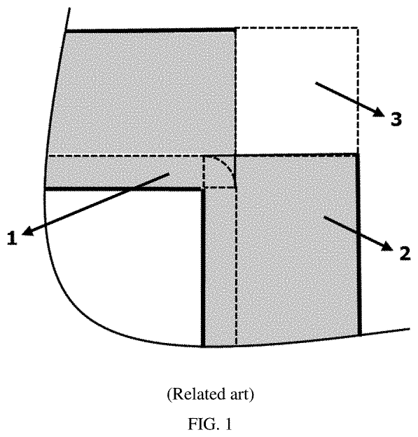

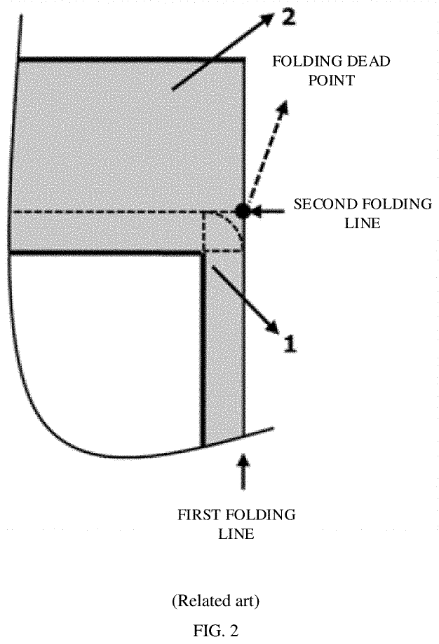

It can be understood that since each two adjacent folding walls 20 are cut to form the special-shaped graphic region 30, no mutual interference occurs during folding of each two adjacent folding walls 20, and thus no folding dead point is formed, and the display panel has high reliability. As illustrated in FIG. 1 and FIG. 2, in the related art, a cutting pattern 3 is generally a rectangle, so that mutual interference may occur during folding of two adjacent folding walls 2. For example, when one folding wall is over-folded, the other folding wall cannot be folded, or a part of a bottom wall 1 close to the rectangle is warped when folding the other folding wall. For another example, when one folding wall is slightly bent, a size of the bottom wall 1 is increased, and as a result, a width of a frame of a display panel may also be increased.

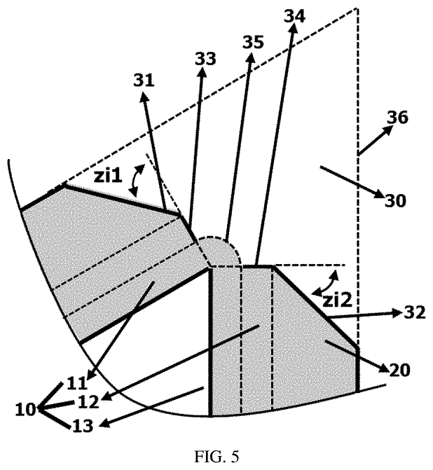

In an implementation of the disclosure, as illustrated in FIG. 3 and FIG. 5, the special-shaped graphic region 30 includes a first edge 31, a second edge 32, a third edge 33, a fourth edge 34, and a fifth edge 35. The first edge 31 and the second edge 32 are respectively located on two adjacent folding walls 20. The third edge 33 and the fourth edge 34 are located on the bottom wall 10 and respectively connected to the first edge 31 and the second edge 32. The fifth edge 35 is connected to the third edge 33 and the fourth edge 34.

In one example, the first edge 31, the second edge 32, the third edge 33, the fourth edge 34, and the fifth edge 35 of the special-shaped graphic region 30 coincide with edges of the bottom wall 10 and the folding walls 20. In addition, the special-shaped graphic region 30 may further include a sixth edge 36 connected to the first edge 31 and the second edge 32, so that the special-shaped graphic region 30 is a closed graphic region. It can be understood that the sixth edge 36 may be a straight-line edge, an arc edge, or a zigzag edge according to actual needs. Since the sixth edge 36 is cut away, the sixth edge 36 has no impact on the implementation of the disclosure, and thus there is no restriction on the shape of the sixth edge 36.

The first edge 31, the third edge 33, the fifth edge 35, the fourth edge 34, and the second edge 32 are connected sequentially. The first edge 31 and the second edge 32 may be arranged symmetrically. Similarly, the third edge 33 and the fourth edge 34 may also be arranged symmetrically. Since the third edge 33, the fourth edge 34, and the fifth edge 35 are all located on the bottom wall 10, and the first edge 31 and the second edge 32 are both located on the folding walls 20, in the plate body, the third edge 33, the fourth edge 34, and the fifth edge 35 are coplanar, and the first edge 31 and the second edge 32 are folded and not coplanar with the third edge 33, the fourth edge 34, and the fifth edge 35. Since the third edge 33, the fourth edge 34, and the fifth edge 35 are arranged between the first edge 31 and the second edge 32, that is, a gap is defined between the first edge 31 and the second edge 32, no mutual interference occurs during folding of the first edge 31 and the second edge 32 and thus no folding dead point is formed.

In an implementation of the disclosure, as illustrated in FIG. 3, the fifth edge 35 is an arc edge. It is to be understood that the fifth edge 35 may also be a straight-line edge or a zigzag edge. A center of a circle where the arc edge is located is at the outside of the special-shaped graphic region 30.

In one example, the center of the circle where the arc edge is located is on a side of the plate body away from the special-shaped graphic region 30, that is, on the bottom wall 10.

In an implementation of the disclosure, as illustrated in FIG. 3, the special-shaped graphic region 30 satisfies the following relationship:

$$\frac{36 {0}^{0}}{N} < ( zi 1 + zi 2 ) < \frac{36 {0}^{0}}{N} \times m$$

where N represents the amount of the folding walls 20, zi1 represents an angle defined between the first edge 31 and an extended line of the third edge 33, zi2 represents an angle defined between the second edge 32 and an extended line of the fourth edge 34, and the coefficient m>1. In the special-shaped graphic region 30, the first edge 31 and the third edge 33 collectively define a concave angle 1, where zi1=concave angle 1-180°, and accordingly, the second edge 32 and the fourth edge 34 collectively define a concave angle 2, where zi2=concave angle 2-180°.

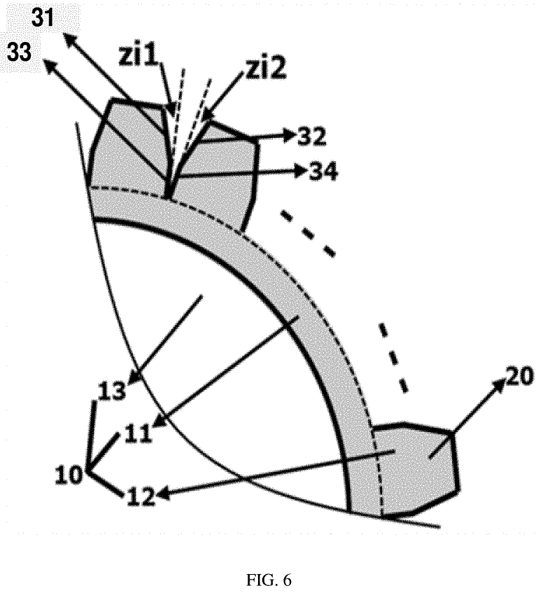

In the implementation of the disclosure, the amount N of the folding walls 20 is an integer larger than 2. The larger N is, the closer the shape of the display panel approaches to a circle (as illustrated in FIG. 6, “ . . . ” indicates the folding walls 20 and a reserved plate 12 that are not illustrated). Since when triangular display panels (as illustrated in FIG. 5), quadrilateral display panels (as illustrated in FIG. 7), or hexagonal display panels are adopted, the display panels can be connected together to form a complete plane, and no gap is defined among the display panels (as illustrated in FIG. 10), the amount N of the folding walls 20 is preferably set to be 3, 4, or 6. Certainly, display panels (N takes different values) can also be adopted to form a complete plane.

In an implementation of the disclosure, the coefficient m is selected from a range from 1.1 to 1.5.

In one example, the larger the coefficient m, the larger an angle defined between the first edge 31 and the second edge 32, and thus interference is not easy to occur during folding. The coefficient m can be set as required. For example, when the coefficient m is set to be 1.2, deployment formulas illustrated in the following table are obtained.

| Shape of a display panel | N | Deployment formula |
|---|---|---|
| Triangle | 3 | 120° < zi1 + zi2 < 144° |
| Quadrilateral | 4 | 90° < zi1 + zi2 < 108° |
| . . . | . . . | . . . |
| Circle (approaching to | 15 | 24° < zi1 + zi2 < 28.8° |
| pentadecagon) | | |

As illustrated in FIG. 5, when the display panel is in the shape of a triangle, an angle defined between two adjacent folding walls 20 is an acute angle, the special-shaped graphic region 30 is not in the shape of a triangle, and thus the two adjacent folding walls 20 do not interfere with each other when the two adjacent folding walls 20 are folded to the back of the bottom wall 10. After the two adjacent folding walls 20 are folded and attached to the back of the bottom wall 10, the two adjacent folding walls 20 do not overlap with each other, i.e., a thickness of the display panel does not increase. A sum of the angle zi1 and the angle zi2 ranges from 120° to 144° (120°˜144°), that is, the sum of the angle zi1 and the angle zi2 is relatively large. In other words, the first edge 31 and the second edge 32 each may have a relatively large variable range.

As illustrated in FIG. 3, when the display panel is in the shape of a quadrilateral, an angle defined between two adjacent folding walls 20 is a right angle, the special-shaped graphic region 30 is not in the shape of a quadrilateral, and thus the two adjacent folding walls 20 do not interfere with each other when the two adjacent folding walls 20 are folded to the back of the bottom wall 10. After the folding walls 20 are folded and attached to the back of the bottom wall 10, the two adjacent folding walls 20 do not overlap with each other, i.e., the thickness of the display panel does not increase. The sum of the angle zi1 and the angle zi2 ranges from 90° to 108° (90°˜108°).

As illustrated in FIG. 6, when the display panel is in the shape of a pentadecagon (i.e., the shape of the display panel approaches to a circle), an angle defined between two adjacent folding walls 20 is an obtuse angle, and thus the two adjacent folding walls 20 do not interfere with each other when the two adjacent folding walls 20 are folded to the back of the bottom wall 10. After the folding walls 20 are folded and attached to the back of the bottom wall 10, the two adjacent folding walls 20 do not overlap with each other, i.e., the thickness of the display panel does not increase. The sum of the angle zi1 and the angle zi2 ranges from 24° to 28.8° (24°˜28.8°), that is, the sum of the angle zi1 and the angle zi2 is relatively small. In other words, the first edge 31 and the second edge 32 each may have a relatively small variable range.

In an implementation of the disclosure, as illustrated in FIG. 7, the bottom wall 10 includes an upper cover 10a, a front plate 10b, and a back plate 10c that are arranged sequentially. The front plate 10b has a display region for luminous display.

The plate body adopts a three-layer structure. The upper cover 10a, the front plate 10b, and the back plate 10c are sequentially connected. The upper cover 10a and the back plate 10c are used for fixing the front plate 10b. The three layers (i.e., the upper cover 10a, the front plate 10b, and the back plate 10c) have a substantially same size. During folding, corresponding parts (i.e., folding walls 20) of the upper cover 10a, the front panel 10b, and the back panel 10c are all folded to the back of the bottom wall 10.

In an implementation of the disclosure, in order to facilitate the folding of the plate body, the bottom wall 10 adopts a flexible plate body, so that a size of a frame can be reduced as much as possible to form an unframed display panel.

In an implementation of the disclosure, a light-emitting source of the front plate 10b is made of inorganic materials. Since when the light-emitting source is made of organic materials, the light-emitting source needs to be packaged with relatively high requirements to avoid water and oxygen, and the folding cannot be performed on a packaging region (once the packaging region is folded, cracks may be formed, and thus water and oxygen may enter the light-emitting source via the cracks). In this case, the packaging region can merely be reserved on the bottom wall, which increases the size of the frame. In the implementation of the disclosure, the light-emitting source of the front plate 10b is made of the inorganic materials, and thus the requirement for packaging the light-emitting source is relatively low, and the packaging region can be folded to form the unframed display panel.

In an implementation of the disclosure, as illustrated in FIG. 8, the bottom wall 10 includes the display region 13 and a corner cutting tolerance reserved region 11 arranged around the display region 13. The display region 13 is a display region for the front plate 10b, which can be configured to allow lights emitted by the front plate 10b to pass through to display information such as image and text. With the corner cutting tolerance reserved region 11, the display region 13 is prevented from being cut during cutting, and thus an area or a shape of the display region 13 is not affected. The corner cutting tolerance reserved region 11 has an equidistant frame structure, that is, the width of the frame structure is uniform.

In an implementation of the disclosure, as illustrated in FIG. 8, the bottom wall 10 further includes a folding tolerance reserved region 12 arranged around the corner cutting tolerance reserved region 11. The folding tolerance reserved region 12 is configured to provide a reserved position for folding processing. That is, during folding, the first edge 31 and the second edge 32 may be allowed to be partially folded or fully folded. When the first edge 31 and the second edge 32 are fully folded, an ideal state occurs, and in this case, the bottom wall 10 merely has the corner cutting tolerance reserved region 11, such that the frame has the minimize size. When the first edge 31 and the second edge 32 are partially folded, the worst state occurs, and in this case, the width of the frame is a sum of a width of the corner cutting tolerance reserved region 11 and a width of the remaining folding tolerance reserved region 12. As can be seen, the width of the frame depends on the width of the folding tolerance reserved region 12. That is, with setting the width of the folding tolerance reserved region 12, the width of the frame can be adjusted. As a result, a display panel having a frame of a relatively small size or an unframed display panel can be formed.

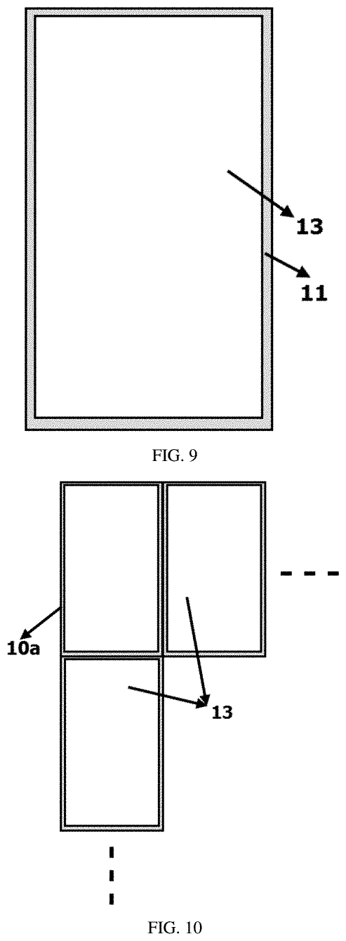

In addition, during folding, the fifth edge 35 (i.e., corner cutting tolerance reserved region 11) is not easily deformed, such that the corner cutting tolerance reserved region 11 can be maintained in a flat state. Since the folding walls 20 do not interfere with each other, no folding dead point may be formed. In addition, with the folding tolerance reserved region 12, a certain error is allowed during the folding of the folding walls 20. That is, even if the certain error occurs during the folding of the folding walls 20, the corner cutting tolerance reserved region 11 may not be affected. In other words, the corner cutting tolerance reserved region 11 is still in the flat state. In this case, an edge distance (i.e., the width of the frame structure) of the corner cutting tolerance reserved region 11 can be reduced as much as possible to obtain the unframed display panel (as illustrated in FIG. 9). Both the third edge 33 and the fourth edge 34 may be arranged to be perpendicular to the corner cutting tolerance reserved region 11 (that is, perpendicular to edges of the corner cutting tolerance reserved region 11).

In an implementation of the disclosure, as illustrated in FIG. 8, each folding wall 20 include a circuit region 21 arranged around the folding tolerance reserved region 12 and an edge cutting tolerance reserved region 22 arranged around the circuit region 21. Circuits can be arranged in the circuit region 21 to provide electric energy for the light-emitting source. The edge cutting tolerance reserved region 22 can be configured to provide reserved positions for cutting of each edge of the display panel, so as to prevent the circuit region 21 from being cut and avoid damage to the circuits.

Implementations of the disclosure further provide a display according to the above implementations for illustrating the display panel.

As illustrated in FIG. 10, (“ . . . ” in FIG. 10 represents display panels not illustrated), the display in the implementation of the disclosure includes a frame and at least one display panel provided in the implementation of the disclosure. According to a size of a display actually required, multiple display panels can be selected and fixed to the frame, and the multiple display panels are electrically coupled with each other, to realize an unframed large-screen display.

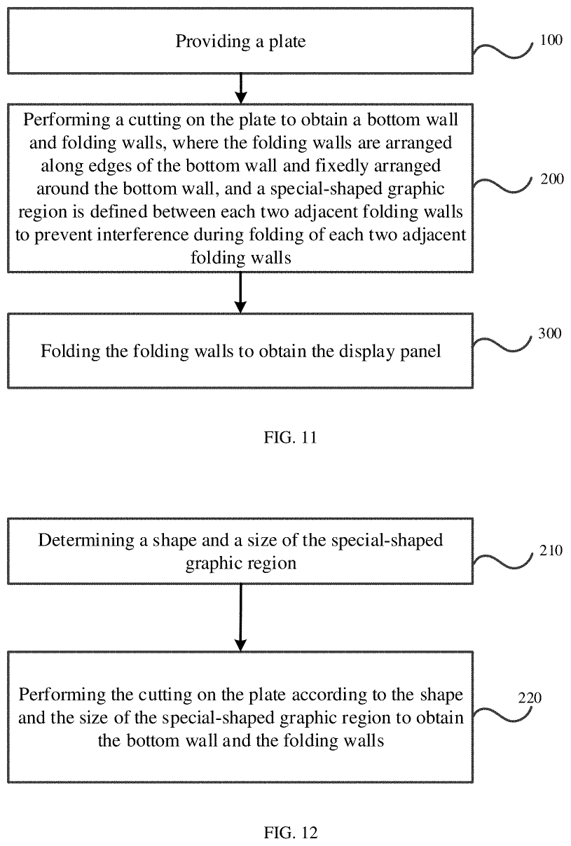

As illustrated in FIG. 11, implementations of the disclosure further provide a method for manufacturing a display panel.

The method for manufacturing a display panel provided in the implementations of the disclosure begins at block 100.

At block 100, a plate is provided.

In one example, the plate is made from metal or plastic. Generally, a metal plate is used to prepare a back plate. A shape of the plate may be set according to actual needs. For example, when a display panel having a triangular shape needs to be prepared, a triangular plate may be provided. For another example, when a display panel having a hexagonal shape needs to be prepared, a hexagonal plate may be provided. For yet another example, when a display panel having a circular shape needs to be prepared, a circular plate may be provided.

At block 200, a cutting is performed on the plate to obtain a bottom wall and folding walls, where the folding walls are arranged along edges of the bottom wall and fixedly arranged around the bottom wall, and a special-shaped graphic region is defined between each two adjacent folding walls to prevent interference during folding of each two adjacent folding walls.

In at least one implementation, as illustrated in FIG. 12, the operation at block 200 includes operations at blocks 210-220.

At block 210, a shape and a size of the special-shaped graphic region is determined.

In one example, the shape of the special-shaped graphic region needs to be determined according to a shape of the finally formed display panel. For example, when the display panel having the triangle shape needs to be prepared, the shape and the size of the special-shaped graphic region are determined according to the following relationships:

$$\frac{36 {0}^{0}}{N} < ( zi 1 + zi 2 ) < \frac{36 {0}^{0}}{N} \times m$$

where N represents the amount of the folding walls, zi1 represents an angle defined between a first edge and an extended line of a third edge of the special-shaped graphic region, zi2 represents an angle defined between a second edge and an extended line of a fourth edge of the special-shaped graphic region, and the coefficient m>1.

In particular, during preparing the display panel having the circular shape, the amount N of the folding walls needs to be determined according to the size of the finally formed display panel. It can be understood that the larger N is, the closer the shape of the display panel approaches to a circle. That is, the display panel having the circular shape is achieved via a regular N-polygon display panel.

At block 220, the cutting is performed on the plate according to the shape and the size of the special-shaped graphic region to obtain the bottom wall and the folding walls.

In at least one implementation, the cutting is carried out by laser cutting. That is, a cutting portion corresponding to the special-shaped graphic region in the plate is cut away to obtain the bottom wall and the folding walls.

At block 300, the folding walls are folded to obtain the display panel.

In one example, folding is performed on each folding wall. Each folding wall is bent from the special-shaped graphic region toward a side of the bottom wall away from a display region of the bottom wall, and is fixed to the side of the bottom wall away from the display region. That is, the display region is located on the front of the bottom wall, and the folding walls are folded to the back of the bottom wall. During folding, due to the folding tolerance reserved region, an error is allowed to occur during folding.

It is to be noted that the display panel manufactured by the above method is the display panel illustrated in FIG. 3 to FIG. 10.

As can be seen, according to the display panel, the method for manufacturing the display panel, and the display that are provided herein, the display panel includes the bottom wall having the display region and the folding walls arranged along the edges of the bottom wall. The folding walls are fixedly arranged around the bottom wall. The special-shaped graphic region is defined between each two adjacent folding walls to prevent interference during folding of each two adjacent folding walls. Each folding wall is bent from the special-shaped graphic region toward the side of the bottom wall away from the display region, and fixed to the side of the bottom wall away from the display region. Since each two adjacent folding walls are cut to form the special-shaped graphic region, no mutual interference occurs during folding of each two adjacent folding walls, and thus no folding dead point is formed, such that the display panel has high reliability.

It should be understood that the disclosure is not limited to the above examples. For those of ordinary skill in the art, improvements or changes can be made based on the above description, and all these improvements and changes should fall within the protection scope of the appended claims of the disclosure.

What is claimed is:

1. A display panel, comprising:
a bottom wall having a display region; and
folding walls arranged along edges of the bottom wall, wherein the folding walls are fixedly arranged around the bottom wall, and a special-shaped graphic region is defined between each two adjacent folding walls to prevent interference during folding of each two adjacent folding walls, wherein each of the folding walls is bent from the special-shaped graphic region toward a side of the bottom wall away from the display region and fixed to the side of the bottom wall away from the display region.

2. The display panel of claim 1, wherein the special-shaped graphic region comprises a first edge, a second edge, a third edge, a fourth edge, and a fifth edge, wherein the first edge and the second edge are respectively located on two adjacent folding walls, the third edge and the fourth edge are located on the bottom wall and respectively connected to the first edge and the second edge, and the fifth edge is connected to the third edge and the fourth edge.

3. The display panel of claim 2, wherein the fifth edge is an arc edge, and a center of a circle where the arc edge is located is at the outside of the special-shaped graphic region.

4. The display panel of claim 2, wherein the special-shaped graphic region satisfies the following relationship:
$$\frac{36 {0}^{0}}{N} < ( zi 1 + zi 2 ) < \frac{36 {0}^{0}}{N} \times m$$
wherein N represents the amount of the folding walls, zi1 represents an angle defined between the first edge and an extended line of the third edge, and zi2 represents an angle defined between the second edge and an extended line of the fourth edge, wherein the coefficient m>1.

5. The display panel of claim 4, wherein the coefficient in is selected from a range from 1.1 to 1.5.

6. The display panel of claim 1, wherein the bottom wall comprises an upper cover, a front plate, and a back plate that are arranged sequentially, wherein the front plate has a display region for luminous display.

7. The display panel of claim 6, wherein the bottom wall is a flexible plate body.

8. The display panel of claim 6, wherein a light-emitting source in the display region of the front plate is made of inorganic materials.

9. The display panel of claim 1, wherein the bottom wall comprises a corner cutting tolerance reserved region arranged around the display region.

10. The display panel of claim 9, wherein the bottom wall further comprises a folding tolerance reserved region arranged around the corner cutting tolerance reserved region.

11. The display panel of claim 10, wherein each of the folding walls comprises a circuit region arranged around the folding tolerance reserved region and an edge cutting tolerance reserved region arranged around the circuit region.

12. A display, comprising:
a frame; and
a plurality of display panels sequentially secured to the frame and sequentially electrically coupled with each other, wherein each of the plurality of display panels comprises:
a bottom wall having a display region; and
folding walls arranged along edges of the bottom wall, wherein the folding walls are fixedly arranged around the bottom wall, and a special-shaped graphic region is defined between each two adjacent folding walls to prevent interference during folding of each two adjacent folding walls, wherein each of the folding walls is bent from the special-shaped graphic region toward a side of the bottom wall away from the display region and fixed to the side of the bottom wall away from the display region.

13. The display of claim 12, wherein the special-shaped graphic region comprises a first edge, a second edge, a third edge, a fourth edge, and a fifth edge, wherein the first edge and the second edge are respectively located on two adjacent folding walls, the third edge and the fourth edge are located on the bottom wall and respectively connected to the first edge and the second edge, and the fifth edge is connected to the third edge and the fourth edge.

14. The display of claim 13, wherein the special-shaped graphic region satisfies the following relationship:
$$\frac{36 {0}^{0}}{N} < ( zi 1 + zi 2 ) < \frac{36 {0}^{0}}{N} \times m$$
wherein N represents the amount of the folding walls, zi1 represents an angle defined between the first edge and an extended line of the third edge, and zi2 represents an angle defined between the second edge and an extended line of the fourth edge, wherein the coefficient m>1.

15. The display of claim 12, wherein the bottom wall comprises an upper cover, a front plate, and a back plate that are arranged sequentially, wherein the front plate has a display region for luminous display.

16. The display of claim 15, wherein a light-emitting source in the display region of the front plate is made of inorganic materials.

17. The display of claim 12, wherein the bottom wall comprises a corner cutting tolerance reserved region arranged around the display region.

18. A method for manufacturing a display panel, comprising:
providing a plate;
performing a cutting on the plate to obtain a bottom wall and folding walls, wherein the folding walls are arranged along edges of the bottom wall and fixedly arranged around the bottom wall, wherein a special-shaped graphic region is defined between each two adjacent folding walls to prevent interference during folding of each two adjacent folding walls; and
folding the folding walls to obtain the display panel.

19. The method of claim 18, wherein performing the cutting on the plate to obtain the bottom wall and the folding walls comprises:
determining a shape and a size of the special-shaped graphic region; and
performing the cutting on the plate according to the shape and the size of the special-shaped graphic region to obtain the bottom wall and the folding walls.

20. The method of claim 18, wherein the cutting is carried out by laser cutting.
